(19) United States
(12) Patent Application Publication
(10) Pub. No.: US 2025/0116352 A1
(43) Pub. Date: Apr. 10, 2025

(54) TEMPERATURE COMPENSATING BIMETALLIC SPRING ENERGIZED MECHANICAL SEAL

(71) Applicant: A.W. CHESTERTON COMPANY, Groveland, MA (US)

(72) Inventors: Michael P. GRIMANIS, Wayland, MA (US); Joseph K. KALESHIAN, Burlington, MA (US)

(21) Appl. No.: 18/908,475

(22) Filed: Oct. 7, 2024

Related U.S. Application Data
(60) Provisional application No. 63/588,565, filed on Oct. 6, 2023.

(51) Int. Cl. F16K 41/04

(52) U.S. Cl. CPC F16K 41/04

(57) ABSTRACT

A sealing assembly for use in a fluid regulating device comprising a seal jacket having a channel formed therein, where the channel has opposed side wall portions and the seal jacket is sized and configured for seating in a channel formed in the fluid regulating device, and a biasing member that is sized and configured for seating in the channel and is formed from at least first and second layers. The first layer is formed from a first metal material and the second layer is formed from a second metal material different than the first metal material. The biasing member places a force on the side wall portions of the channel when mounted therein. The first and second layers of the biasing member can be secured together to form a bimetallic biasing member.

### Related Applications

This application claims priority to U.S. provisional patent application Ser. No. 63/588,565, filed on Oct. 6, 2023, and entitled TEMPERATURE COMPENSATING BIMETALLIC SPRING ENERGIZED MECHANICAL SEAL, the contents of which are herein incorporated by reference.

### BACKGROUND OF THE INVENTION

Spring energized or loaded mechanical seals provide durable and reliable sealing solutions in important industrial and commercial applications. Conventional spring-loaded mechanical seals are essential components used in various rotating or reciprocating equipment, such as pumps, compressors, mixers, and valves, to prevent the leakage of fluids (e.g., liquids or gases) between the shaft and a stationary housing. These conventional seals are designed to create a tight and reliable barrier between the two components, ensuring the efficient and safe operation of the machinery. The conventional mechanical seal typically consists of a stationary face or component and a rotating face or component. The stationary face is typically attached to the equipment's housing or stationary component, while the rotating face is connected to the movable shaft. The primary sealing interface occurs between the stationary and rotating faces.

The conventional spring energized seals typically include a seal jacket that houses a biasing member, such as a spring. The spring can exert a controlled force on the seal jacket forming the stationary face and can press or force the seal jacket against the rotating face, such as the shaft. The sealing force created by the spring and the seal jacket ensures that the sealing faces remain in sealing contact with each other, creating a seal that can accommodate minor axial or radial shaft movements and vibrations (e.g., shaft run out). The seal jacket is employed to house and protect the biasing spring. The seal jacket thus provides support and maintains the proper alignment between the stationary and rotating faces.

When the seal is installed into a seal cavity within the stationary housing, the seal jacket and spring energizer are deformed or compressed in a radial direction. The spring energizes the seal jacket, providing resilience to the sealing surfaces (e.g., seal lips) and pushes the seal lips in a radial direction, thus resulting in an effective sealing device in both dynamic and static applications. Further, the radial force or tension created and maintained by the spring in the seal jacket keeps the seal lips in contact with the counter surfaces. When system pressure is applied, the spring action is intensified. This increases the sealing force on the seal lips, improving the sealing efficiency. Spring energized seals can be used in both dynamic and static applications. Dynamic applications cover reciprocating (linear), rotary, and oscillating movements or any combination thereof.

Conventional spring-loaded mechanical seals can be widely used in industrial settings to prevent the leakage of hazardous or valuable fluids and can come in various designs and configurations to suit specific operating conditions and requirements. Proper maintenance, monitoring, and adjustment of the seals is required to ensure their long-term effectiveness and reliability in sealing applications.

Spring-energized mechanical seals offer many advantages, such as reliable sealing performance and versatility in various applications. However, these conventional seals suffer from drawbacks and limitations. Conventional spring-energized mechanical seals have a relatively complex design compared to other sealing methods, which can make them more challenging to install, maintain, and replace. This complexity can also lead to higher manufacturing costs. While the spring-energized design is known for its ability to maintain consistent sealing pressure, the contact between the seal face and the shaft can lead to wear over time. This wear can result in reduced sealing efficiency and may necessitate more frequent replacement or refurbishment of the seals. Further, spring-energized mechanical seals are sensitive to shaft misalignment and vibration, which can cause premature wear and lead to sealing failures. The spring-energized mechanical seals are also sensitive to abrasive or corrosive contaminants present in the process fluid. The contaminants can accelerate wear on the sealing faces and reduce the lifespan of the seal. Still further, when compared to alternative sealing systems, such as lip seals or labyrinth seals, spring-energized mechanical seals require more frequent maintenance, adjustments, and monitoring to ensure their continued performance.

### SUMMARY OF THE INVENTION

The present invention is directed to a sealing assembly suitable for use with a fluid regulating device that employs a multi-layer biasing member that is mounted in a sealing jacket. The multi-layer biasing member can be configured to flex in a selected manner based on the type of materials being employed in the specific layers. The biasing member can have first and second layers formed from different materials having different coefficients of thermal expansion. According to on embodiment, the first layer can be formed of a first material having a first coefficient of thermal expansion and the second layer can be formed from a second material having a different coefficient of thermal expansion. For example, the first material can be formed from a first metal material having a high coefficient of thermal expansion and the second layer can be formed from a second metal material having a low coefficient of thermal expansion. The material with the higher coefficient of thermal expansion expands and contracts at rates or amounts greater than the material with the lower coefficient of thermal expansion, and as such, the biasing member can bend or deflect in a selected direction based on the material with the higher coefficient of thermal expansion.

According to one embodiment, the present invention is directed to a sealing assembly for use in a fluid regulating device for forming a seal with a movable shaft comprising a seal jacket having a main body having a channel formed therein, where the channel has opposed side wall portions and the seal jacket is sized and configured for seating in a channel formed in the fluid regulating device, and a biasing member that is sized and configured for seating in the channel and is formed from at least first and second layers. The first layer is formed from a first metal material and the second layer is formed from a second metal material different than the first metal material. The biasing member places a force, such as an activation or energizing force, on the side wall portions of the channel when mounted therein. The first and second layers of the biasing member can be secured together to form a bimetallic biasing member. Further, the seal jacket has a base portion that is sized and dimensioned for seating within the channel formed in the fluid regulating device.

The first metal material has a first coefficient of thermal expansion and the second metal material has a second coefficient of thermal expansion, and the first coefficient of thermal expansion is different than the second coefficient of thermal expansion. According to one embodiment, the first metal material has a high coefficient of thermal expansion and the second metal material has a low coefficient of thermal expansion. Conversely, the first metal material can have a low coefficient of thermal expansion and the second metal material can have a high coefficient of thermal expansion. The first layer and the second layer can be joined or secured (e.g., brazed or welded) together. The biasing member can be configured as a spring element having a spiral shape or a a U-shaped configuration. According to one embodiment, the first layer is formed of brass and the second layer is formed of steel.

According to another embodiment, the first metal material of the first layer is formed from one of brass, stainless steel, nickel-based alloys low-alloy steel, bronze, nickel-manganese steel, nickel, and nickel-silver and manganese bronze, and the second metal material of the second layer is formed from one of nickel-iron alloys, alloy 42, Haynes 188, Inconel, nickel-based alloys, and steel. According to another embodiment, the first metal material of the first layer is selected from the group consisting of brass, stainless steel, nickel-based alloys low-alloy steel, bronze, nickel-manganese steel, nickel, and nickel-silver and manganese bronze, and the second metal material of the second layer is selected from the group consisting of nickel-iron alloys, alloy 42, Haynes 188, Inconel, nickel-based alloys, and steel.

The present invention is also directed to a method of forming a sealing assembly for use in a fluid regulating device for forming a seal with a movable shaft, comprising providing a seal jacket having a main body having a channel formed therein, where the channel has opposed side wall portions and the seal jacket is sized and configured for seating in a channel formed in the fluid regulating device, and forming a biasing member that is sized and configured for seating in the channel and is formed from at least first and second layers. The first layer is formed from a first metal material and the second layer is formed from a second metal material different than the first metal material. The biasing member places a force (e.g., an activation or energizing force) on the side wall portions of the channel when mounted therein. The first and second layers of the biasing member are secured together to form a bimetallic biasing member. Further, the seal jacket is configured to have a base portion that is sized and dimensioned for seating within the channel of the fluid regulating device.

According to another embodiment of the method of the present invention, the first metal material has a first coefficient of thermal expansion and the second metal material has a second coefficient of thermal expansion, where the first coefficient of thermal expansion is different than the second coefficient of thermal expansion. The biasing member can have a spiral shape or a U-shaped configuration.

According to another embodiment of the method of the present invention, the first metal material of the first layer is formed from one of brass, stainless steel, nickel-based alloys low-alloy steel, bronze, nickel-manganese steel, nickel, and nickel-silver and manganese bronze, and the second metal material of the second layer is formed from one of nickel-iron alloys, alloy 42, Haynes 188, Inconel, nickel-based alloys, and steel. Alternatively, the first metal material of the first layer is formed from a group consisting of brass, stainless steel, nickel-based alloys low-alloy steel, bronze, nickel-manganese steel, nickel, and nickel-silver and manganese bronze, and the second metal material of the second layer is formed from a group consisting of nickel-iron alloys, alloy 42, Haynes 188, Inconel, nickel-based alloys, and steel.

### BRIEF DESCRIPTION OF THE DRAWINGS

These and other features and advantages of the present invention will be more fully understood by reference to the following detailed description in conjunction with the attached drawings in which like reference numerals refer to like elements through the different views. The drawings illustrate principals of the invention and, although not to scale, show relative dimensions.

FIG. 1 is an exemplary fluid regulating device employing the sealing assembly of the present invention/FIG. 2 is an exploded partial cross-section view of the sealing assembly of the present invention mounted within the fluid regulating device of FIG. 1 according to the teachings of the present invention.

FIG. 3 is a cross-sectional view of one embodiment of the sealing assembly of the present invention.

FIG. 4 is a partial perspective view of the sealing assembly of FIG. 3 according to the teachings of the present invention.

FIG. 5 is a partial cut-away perspective view of the sealing assembly of FIG. 3 according to the teachings of the present invention.

FIG. 6 is a partial perspective view of the biasing member of the sealing assembly of FIG. 3 according to the teachings of the present invention.

FIGS. 7A-7C are cross-sectional views of an example bimetallic biasing member showing the biasing member in a neutral position and flexed positions as a function of temperature according to the teachings of the present invention.

FIG. 8 is a cross-sectional view of another embodiment of the sealing assembly of the present invention.

FIG. 9 is a partial perspective view of the sealing assembly of FIG. 8 according to the teachings of the present invention.

FIGS. 10A and 10B are perspective views of still further embodiments of the biasing member of the sealing assembly of the present invention.

FIGS. 11 and 12 are perspective views of example bimetallic biasing members suitable for use in the sealing assembly of the present invention.

### DETAILED DESCRIPTION

The terms “mechanical seal assembly,” “mechanical seal,” and “sealing system” as used herein are intended to include various types of mechanical fluid sealing systems and sealing assemblies, including single or solid seals, split seals, concentric seals, spiral seals, gas seals, cartridge seals, spring-energized seals, and other known mechanical seal and sealing types and configurations.

The term “sealing assembly” is intended to refer to a combination of components that can be mounted in or coupled to stationary equipment, and the components can be sized and configured to form a secure and effective seal with the shaft associated with the stationary equipment. The sealing assembly can include multiple sealing components forming a sealing element assembly that is mounted or coupled to the stationary equipment or an optional gland element for forming a seal between the stationary equipment (or gland element) and the shaft. The sealing components depend upon the type of sealing assembly employed. For example, in a cap seal, the sealing components can include an energizer element and a sealing or cap element. The sealing assembly can also include a packing assembly having a series of individual packing elements. The packing elements can be optionally braided packing elements formed from suitable packing material. Still further, the sealing assembly can include a seal jacket forming a sealing component and an associated biasing member.

The term “packing assembly” or “packing loading assembly” as used herein is intended to include any selected component or assembly of components, including at least for example a gland, for applying an axial loading pressure to the packing material so as to provide a seal between the stationary and movable components of at least the stationary equipment. The packing assembly can include one or more packing elements, such as a braided packing element formed of a suitable packing material.

The term “packing material” as used herein is intended to include resilient and at least partially compressible materials for sealing a variety of fluids in a gland or stationary equipment under a wide array of pressures and temperatures.

The terms “stationary equipment,” “stuffing box” and/or “static surface” as used herein are intended to include any suitable stationary structure housing a shaft to which a seal or packing loading assembly having an optional gland or other structure is secured. The stationary equipment can optionally house a process medium. The stationary structure can include any type of commercial or industrial equipment such as pumps (e.g., a plunger pump), valves, and the like. Those of ordinary skill in the relevant art will readily recognize that the gland can form part of the mechanical seal, packing loading assembly, or the stationary equipment.

The terms “process medium” and/or “process fluid” as used herein generally refers to the medium or fluid being transferred through the stationary equipment. In pump applications, for example, the process medium is the fluid being pumped through the pump housing.

The term “gland” as used herein is intended to include any suitable structure that enables, facilitates or assists securing the mechanical seal or the sealing assembly to the stationary equipment, while concomitantly surrounding or housing, at least partially, one or more seal components. If desired, the gland can also provide fluid access to the mechanical seal.

The term “shaft” is intended to refer to any suitable device in a mechanical system to which a mechanical seal can be mounted and includes shafts, rods, plungers, pistons, and other known devices. The shafts can move in any selected direction, such as for example in a rotary direction or in a reciprocating direction.

The terms “axial” and “axially” as used herein refer to a direction generally parallel to the axis of a shaft. The terms “radial” and “radially” as used herein refer to a direction generally perpendicular to the axis of a shaft. The terms “fluid” and “fluids” refer to liquids, gases, and combinations thereof.

The term “axially inner” or “axially inboard” as used herein refers to that portion of the stationary equipment and/or components of a mechanical seal that are disposed proximate to the stationary equipment (e.g., mechanical system) employing the mechanical seal. As such, this term also refers to the components of the mechanical seal or packing loading assembly that are mounted to or within the stationary equipment or are disposed the deepest within or closest to the equipment (e.g., inboard). Conversely, the term “axially outer” or “axially outboard” as used herein refers to the portion of stationary equipment and the mechanical seal or packing loading assembly that is disposed distal (e.g., outboard) from the equipment.

The term “radially inner” as used herein refers to the portion of the mechanical seal, packing loading assembly or associated components that are proximate to a shaft. Conversely, the term “radially outer” as used herein refers to the portion of the mechanical seal, packing loading assembly or associated components that are distal from the shaft.

The term “fluid regulating device” is intended to encompass any selected device that helps, assists, prevents, or regulates the flow or pumping of a fluid through a fluid transport or conveyance medium, such as a pipe. The fluid regulating device is preferably of a type that employs a mechanical seal that employs a sealing assembly, and can include for example pumps, valves, regulators, and the like.

The term “ambient environment” or “ambient pressure” is intended to include any external environment or pressure other than the internal environment of the gland, packing loading assembly, mechanical seal or stationary equipment.

The mechanical seal of the present invention can be employed in a fluid regulating deice that has stationary equipment and a movable shaft. According to one practice, the fluid regulating device can be a valve having a reciprocating shaft and the mechanical seal can be a spring-loaded or spring energized mechanical seal. The valve can have any selected size and shape, and can be, for example, a hydraulic valve, a manual valve, a pneumatic valve, a solenoid valve, a motor valve, or the like. Types of valves that are suitable for use with the present invention can also include a block valve having a gate, butterfly, ball and plug valves, a control valve, or a check valve including quarter turn and globe valves.

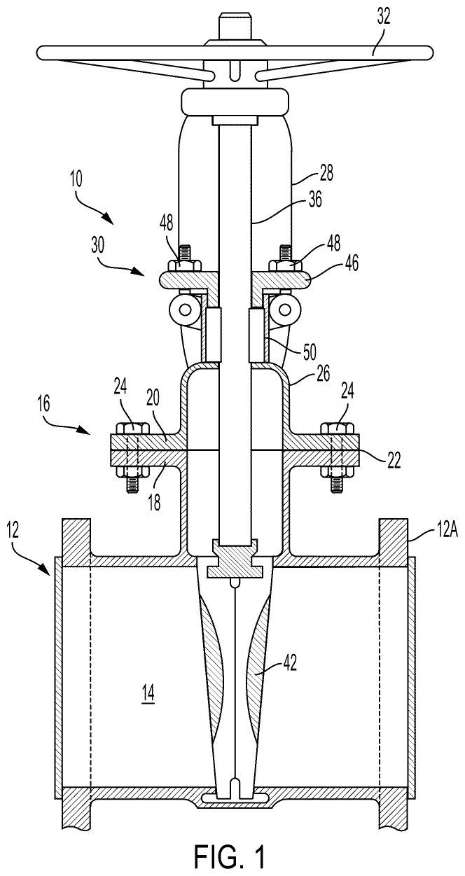

FIG. 1 is a schematic cross-sectional view of an exemplary fluid regulating device 10, such as a block valve, that employs a mechanical seal that includes the sealing assembly 50 of the present invention. Those of ordinary skill in the art will readily recognize that the block valve illustrated herein is only one type of fluid regulating device that can be used with the sealing assembly 50 of the present invention, and that other types of fluid regulating devices can also be used. The illustrated fluid regulating device 10 is shown for purposes of illustration and for the sake of simplicity and clarity. The illustrated fluid regulating device 10 includes a body portion 12 that functions as stationary equipment and can have an opening or chamber 14 formed therein. Each end of the body portion 12 can be configured to be coupled to a fluid pipe that carries the fluid to be regulated by the valve 10. The body portion 12 of the fluid regulating device 10 can be unitary or can have multiple sections that are coupled together. For example, the body portion 12 can include a bonnet portion or section 16. The bonnet portion 16 is typically formed of a first bonnet portion 18 that is coupled to, for example, the bottom body portion 12A, and a second bonnet portion 20 that is coupled to the remainder of the body portion 12, including the integrally formed bonnet bushing 26. A gasket 22 can be mounted between the first and second bonnet portions 18, 20, which are then secured together via suitable fasteners, such as the illustrated bolt and nut assemblies 24, 24. The bonnet bushing 26 is coupled to a yoke portion 28 via a gland 30. The yoke 28 is then coupled to a pressure application device, such as a handwheel 32. Typically, the gland 30 can comprise nose elements that are independent elements of the bonnet and yoke of the valve 10. The yoke 28 can be cast or formed as part of the bonnet assembly to support the valve stem and thrust bearing. As such, the gland 30 can be removable sub-sections of the bonnet bushing 26 connected by the gland bolts 48.

The illustrated handwheel 32 is coupled to one end of a movable shaft, such as a vertically movable or reciprocating valve stem 36. The handwheel 32 when rotated serves to move the valve stem 36 upwards and downwards in a vertical direction depending upon the direction of rotation of the wheel. The valve stem 36 is coupled at the other end to a valve wedge assembly 42 that is disposed in the chamber 14. The valve wedge assembly 42 serves to regulate the flow of fluid passing through the body portion 12 depending upon the position of the assembly 42 within the chamber 14. The gland 30 can include a gland element 46 that seats against the spring-loaded sealing assembly 50 when mounted therein. The gland element 46 can be moved in the vertical direction by tightening the gland bolts 48, 48. When the gland bolts are tightened, the sealing assembly 50 is further compressed by the gland element 46. The sealing assembly 50 is intended to form a fluid tight seal with the valve stem 36 (e.g., shaft). The sealing assembly 50 can be disposed about the valve stem 36 and provides an interface and dynamic sealing surface between the valve stem and the remainder of the fluid regulating device.

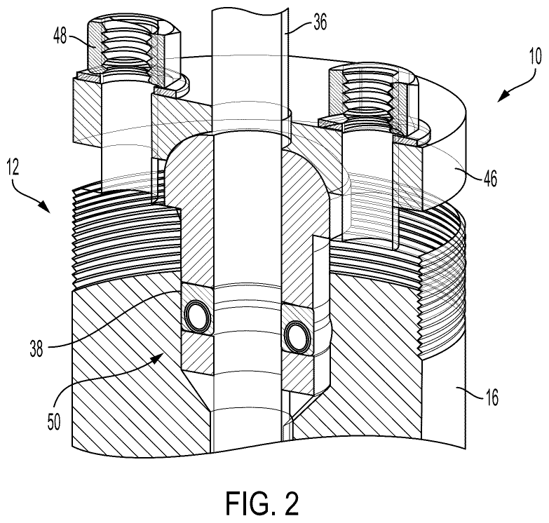

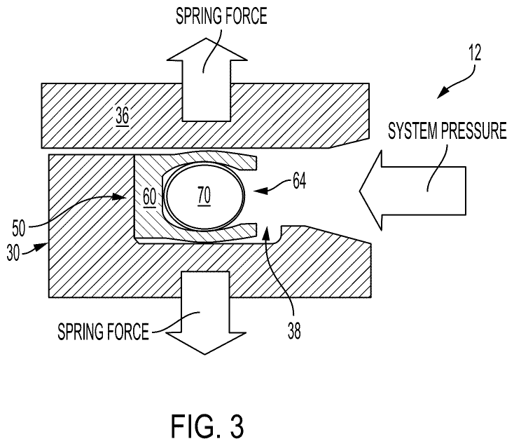

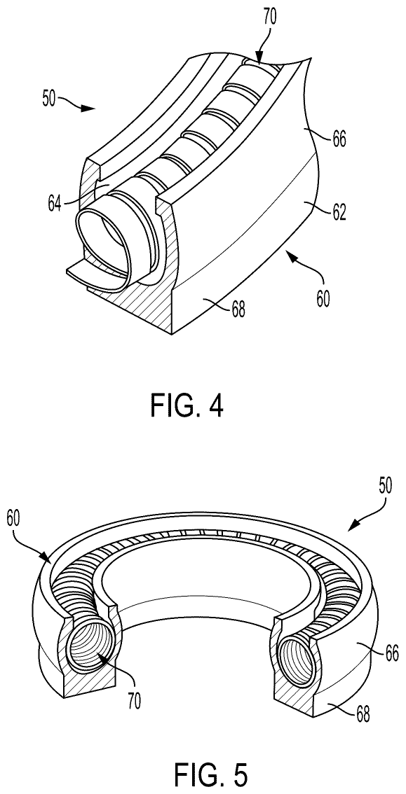

FIG. 2 is a further illustration of the fluid regulating device 10 employing the scaling assembly 50 of the present invention. Specifically, FIG. 2 shows a partial cross-sectional view of the fluid regulating device 10 having the body portion 12 (e.g., stationary equipment) that includes a bonnet portion 16 having a channel 38 or space formed therein for mounting the sealing assembly 50 of the present invention. The sealing assembly 50 can be a spring-loaded bi-metallic sealing assembly for forming a seal with the valve stem 36. A first embodiment of the illustrated sealing assembly 50 suitable for mounting in the fluid regulating device 10 is shown for example in FIGS. 3-6. The illustrated sealing assembly 50 can include multiple components or members, including for example a seal jacket or housing element 60 that functions as a scaling element and a biasing member 70 for biasing the seal jacket 60 into sealing engagement with the shaft 36 and with the stationary equipment. The seal jacket 60 can have any selected shape or configuration and preferably has a main body 62 that has a channel 64 formed therein. The channel 64 forms a pair of opposed side wall portions 66. The main body 62 also includes a base portion 68. The channel 64 is sized and configured for seating a biasing member 70. The sidewall of the seal jacket 60 is configured to contact a mating or outer surface of the shaft 36 to create or form a fluid seal or barrier to prevent leakage of a process fluid or medium. The opposed side wall portion is configured to contact the stationary equipment. The seal jacket 60 can be configured with specific geometries if desired, such as lips, grooves, or other shapes that allow the jacket to effectively conform to the surface of the shaft 36 or other sealing surfaces. The seal jacket 60 can be formed from any suitable material, such as for example from a polymer material such as polytetrafluoroethylene (PTFE), ultra-high-molecular-weight polyethylene (UHMWPE), other types of high-performance engineered plastics, and the like.

The biasing member 70 helps provide the sealing or energizing force to maintain contact between the seal jacket 60 and the shaft 36 and the stationary equipment. The biasing member 70 can be configured as a spring-like clement that exerts a generally consistent or constant radial force on the side walls 66 of the channel 64 so as to ensure that the jacket maintains fluid sealing or intimate facing contact with the shaft 36 and the stationary equipment even as the seal jacket wears over time or as the system experiences fluctuations in pressure or temperature. The energizing action of the biasing member 70 ensures that the seal jacket 60 maintains proper contact with the mating surface of the shaft, creating a tight seal. The energizing force compensates for any wear or changes in the seal jacket properties due to temperature variations or chemical exposure. As the system temperature fluctuates, the dimensions of the biasing member 70 can change due to thermal expansion or contraction of the spring material. This can adversely affect sealing force in order to maintain an effective seal.

Conventional systems typically employ a biasing member having a single layer made from a single type of material and utilizes the force versus displacement characteristics of the spring geometry and material properties (i.e. spring constant) to form a seal. The present invention uses a biasing member 70 having multiple layers formed from different types of material. The biasing member 70 can thus employ two or more layers where at least two of the layers are formed from different types of material. According to one embodiment, the biasing member is formed from two or more layers formed from different types of metal materials. According to another embodiment, the biasing member 70 is formed from two layers formed from different metal materials to form a bimetallic biasing member that responds to temperatures and compensates for the changes in temperatures. The spring force generated by the biasing member 70 can remain at appropriate levels to maintain leak free seal conditions.

The illustrated biasing member 70 can be, for example, a spring element having any selected size, shape or configuration. In the illustrated embodiment, the biasing member 70 has a spiral shape. The biasing member 70 can be formed from multiple layers formed from multiple different types of materials, such as from different types of metal materials, having different coefficients of thermal expansion (CTE). According to one embodiment, the biasing member 70 can be formed from two different types of metal materials, thus forming a bimetallic spring or biasing member. According to one embodiment, the biasing member 70 can employ multiple layers of dissimilar or different metal material that can be secured together, sch as by bonding, to form an essentially monolithic or unitary component. The metal materials can have different coefficients of thermal expansion, such that heating or cooling the metal materials can cause deformation of the materials in a predicable dimension and direction.

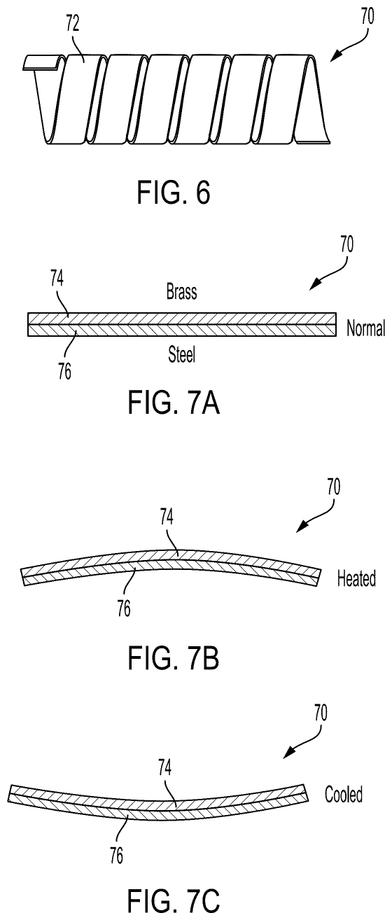

An example of a bimetallic biasing member 70 employing multiple layers formed from different types of metal materials forming part of the sealing assembly 50 is shown for example in FIGS. 6 and 7A-7C. The illustrated biasing member 70 can have a main body 72 that can be formed from multiple layers 74, 76, where each layer is formed from a different type of metal material. The metal materials can have different coefficients of thermal expansion. The metal materials can include metals or metal alloys. For example, the layer 74 can be formed of a first metal material having a first coefficient of thermal expansion and the layer 76 can be formed from a second different metal material having a second coefficient of thermal expansion that is different than the first coefficient of expansion. According to one embodiment, the layers 74, 76 can employ low and high expansion materials. For example, the layer 74 can be formed from brass and the layer 76 can be formed from steel. The layers 74, 76 can be secured or bonded together through known securing or bonding techniques. The use of dissimilar metal materials bonded together to form a laminate structure creates essentially a monolithic material. With each of the metal materials having different coefficients of thermal expansion, heating or cooling of the metal material can result in a selected deformation of the material in a predicable dimension and direction. As shown in FIG. 7A, when the biasing member 70 is subjected to normal temperatures, then the layers do not move or bend from an original position or shape. If the biasing member 70 is heated, as shown in FIG. 7B, then the biasing member 70 bends in a selected predetermined direction. Specifically, each layer 74, 76 expands, but because the metal material of each layer has a different coefficient of thermal expansion, the layer 76 with the material having the higher thermal expansion coefficient expands more than the layer 74 formed from a material having a smaller coefficient of thermal expansion. Since one layer 76 expands more than the other layer 74, the biasing member 70 tends to bend or curve in the direction of the layer 76 made with the material having the higher or greater coefficient of expansion. The amount of bending in the layers and hence the biasing member 70 depends on the temperature increase and the difference in the thermal expansion coefficients. Further, if the biasing member 70 is cooled, as shown in FIG. 7C, then the biasing member 70 bends in an opposite direction. Specifically, each layer 74, 76 contracts, but because the metal material of each layer has a different coefficient of thermal expansion, the layer 76 with the higher thermal expansion coefficient contracts more than the layer 74 with the lower coefficient of thermal expansion. Since one layer 76 contracts more than the other layer 74, the biasing member 70 tends to bend or curve in the opposite direction, and hence in the direction of layer 74.

The bimetallic biasing member of the present invention can find application in various industries, including aerospace, automotive, oil and gas, pharmaceuticals, and food processing. The biasing members can be used in rotary or reciprocating equipment, such as in valves, pumps, compressors, and other machinery where effective sealing is important. Conventional scaling assemblies are challenged due to extreme temperatures. In the case of low temperature cryogenic applications (e.g. valves), contraction due to negative coefficients of expansions of the materials and the very low temperatures of liquefied gases current spring materials do not maintain sufficient sealing loads. The sealing assembly of the present invention compensates for the change in temperature by maintaining and/or increasing the spring load.

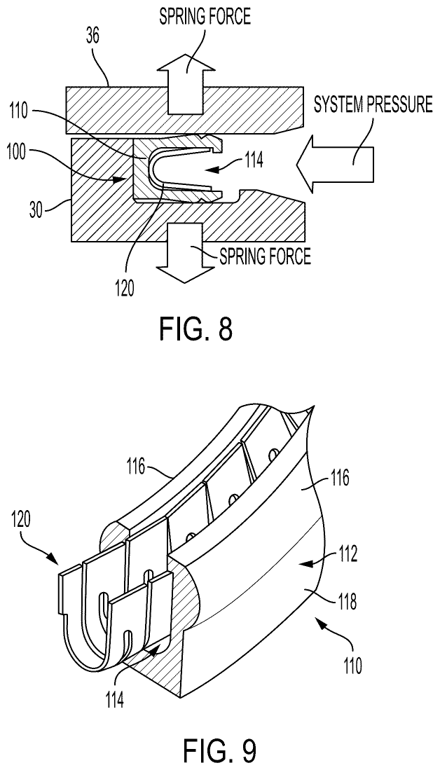

FIGS. 8 and 9 show another embodiment of the sealing assembly according to the teachings of the present invention. The illustrated sealing assembly 100 can include multiple components or members, including for example a seal jacket or housing element 110 that functions as a scaling element and a biasing member 120 that functions as a spring for biasing the seal jacket 110 into sealing engagement with the shaft 36 and with the stationary housing (e.g., gland 30). The seal jacket 110 can have any selected shape or configuration and preferably has a main body 112 that has a channel 114 formed therein. The channel 114 forms a pair of opposed side wall portions 116. The main body 112 also includes a base portion 118. The channel 114 is sized and configured for seating a biasing member 120. The seal jacket 110 is configured to contact a mating or outer surface of the shaft 36 to create or form a fluid seal or barrier to prevent leakage of a process fluid or medium. The seal jacket 110 can be configured with specific geometries if desired, such as lips, grooves, or other shapes that allow the jacket to effectively conform to the surface of the shaft 36 or other sealing surfaces. The seal jacket 110 can be formed from any suitable material, such as for example from a polymer material such as polytetrafluoroethylene (PTFE), ultra-high-molecular-weight polyethylene (UHMWPE), or other high-performance engineered plastic.

The biasing member 120 helps provide the sealing or energizing force to maintain contact between the seal jacket 110 and the shaft 36. The biasing member 120 can be configured to exert a consistent radial force on the side walls 116 of the channel 114 so as to ensure that the jacket maintains fluid sealing or intimate facing contact with the shaft 36 even as the seal wears over time or as the system experiences fluctuations in pressure or temperature. The energizing action of the biasing member 120 ensures that the seal jacket 110 maintains proper contact with the mating surface of the shaft, creating a tight seal. The energizing force compensates for any wear or changes in the seal jacket properties due to temperature variations or chemical exposure. As the system temperature fluctuates, the dimensions of the biasing member 120 can change due to thermal expansion or contraction of the spring material. This can adversely affect sealing force in order to maintain an effective seal. The biasing member 120 can have a generally U-shaped configuration.

The illustrated biasing member 120 can be configured to include multiple layers formed from different types of materials, such as from different types of metal materials. As illustrated in FIGS. 7A-7C, the biasing member 120 can be configured as a bimetallic biasing member formed from two different types of metal materials. The biasing member 70 can employ layers 74, 76 of dissimilar metal material that can be secured or bonded together to form a monolithic component. The metal materials can have different coefficients of thermal expansion, such that heating or cooling of the metal materials can cause deformation of the materials in a predicable dimension and direction. Specifically, the layer 74 can be formed of a first metal material having a first coefficient of expansion and the layer 76 can be formed from a second different metal material having a second coefficient of expansion that is different than the first coefficient of expansion.

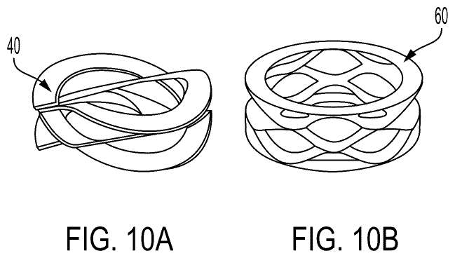

FIGS. 10A and 10B illustrate additional embodiments of the biasing member that can be used with the sealing assembly of the present invention. In these embodiments, the sealing assembly can include a biasing member 140 having a wave-shaped configuration, as shown in FIG. 10A. Alternatively, the biasing member 160 can have a three-dimensional matrix configuration, as shown in FIG. 10B.

As described herein, the biasing member forms part of the sealing assembly and creates or generates a sealing or energizing force that forces a seal jacket into mating sealing contact with a mating surface of the gland 30 and the shaft 36, so as to maintain sealing contact between the seal jacket 60 and the mating surfaces. Specifically, the biasing member can be configured to exert a relatively constant radial force on the seal jacket, thus ensuring that the seal jacket maintains contact with the inner surface of the gland and the outer surface of the shaft, even as the seal jacket wears over time or as the system experiences fluctuations in pressure or temperature. The energizing or biasing action of the biasing member ensures that the seal jacket maintains proper contact with the mating surface of the shaft, creating a fluid-tight seal. As the system temperature fluctuates, the dimensions of the seal jacket can change due to thermal expansion or contraction of the spring material. This can adversely affect sealing force in order to maintain an effective seal. The biasing member of the sealing assembly of the present invention can be configured as a bimetallic biasing member that responds to temperature and compensates for the change in temperature by maintaining or increasing the energizing force (e.g., spring load). As such, the material can be selected such that the spring force remains at appropriate levels during use to maintain leak free seal conditions.

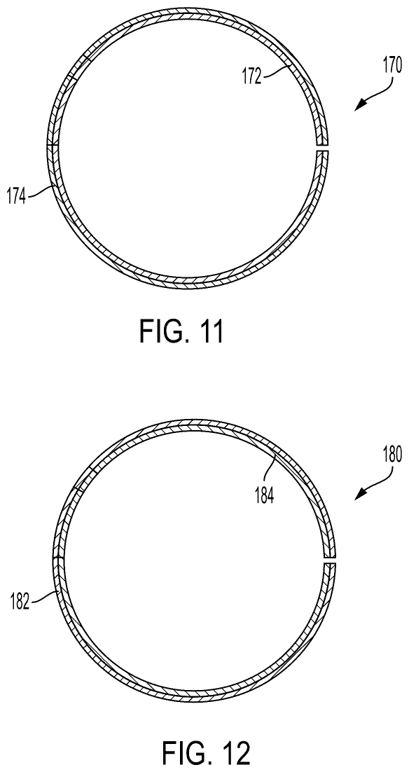

FIGS. 11 and 12 illustrate an example of the biasing member being formed from two or more layers formed from a bimetallic material. According to one embodiment, the biasing member can be formed from two layers, where each layer is formed from a different metal material. As used herein, the term “bimetallic” or “bimetallic material” is intended to mean forming a biasing member from at least two different types of metals and/or metal alloys having different coefficients of thermal expansion, such that the metals expand and contract at different rates when subjected to changes in temperature. As such, the bimetallic material can include multiple metals, multiple metal alloys, a metal and a metal alloy, and the like. The different rates and amounts of expansion and contraction of the two metals or metal alloys relative to each other can cause the biasing member to move, bend or warp in a selected or predetermined manner or direction. The two different types of metal materials can be joined or secured together by any suitable process, such as by bimetallic bonding, which involves physically combining or bonding two distinct metals or metal alloys to create a composite material with unique properties. The different metal materials can also be joined by bonding, welding or brazing techniques, such as by explosive welding, roll bonding, diffusion bonding, and the like. The choice of joining technique depends on factors such as the types of metal materials being employed, the intended application, and the desired properties of the resulting bimetallic material. The metals can include, for example, iron, copper, aluminum, gold, lead, tin, zinc, nickel, titanium, and the like. The metal alloys can be materials that include a combination of two or more metallic elements or a metal with one or more non-metallic elements. The metal alloys can be created to enhance the properties of metals for specific applications. Examples of metal alloys can include steel (e.g., an alloy of iron and carbon and often other elements such as chromium, nickel, or manganese), bronze (e.g., an alloy of copper and tin), brass (e.g., an alloy of copper and zinc), aluminum alloy (e.g., aluminum with one or more elements such as copper, magnesium, or silicon), nitinol (e.g., an alloy made of nickel and titanium), pewter (e.g., an alloy of tin with selected amounts of antimony, copper, and sometimes silver), monel (e.g., an alloy of nickel and copper), hastelloy (e.g., a family of nickel-based alloys), invar (e.g., an alloy of iron and nickel), eligiloy (e.g., a super-alloy that consists of cobalt, chromium, nickel, iron, manganese and trace amounts of carbon), and the like.

According to one embodiment, one or more layers of the multi-layer biasing member can include high expansion metal materials having higher coefficients of thermal expansion including metals or metal alloys such as brass (e.g., copper and zinc, such as 70 Cu and 30 Zn), stainless steel or nickel-based alloys (e.g., includes nickel, chromium and iron, such as for example 22 Ni 3 Cr Bal Fe, 25 Ni 8.5 Cr Bal Fe, 18 Ni 11.5 Cr Bal Fe, 19 Ni 7 Cr Bal Fe, 18 Cr 8 Ni Bal Fe), low-alloy steels (e.g., includes nickel, chromium, carbon and iron, such as 19.4 Ni, 2.25 Cr, 0.5C and Bal Fe), bronze (e.g., includes tin and copper, such as 5 Sn Bal Cu), nickel-manganese steel, alloys or superalloys (e.g., includes nickel, manganese and iron, such as 20 Ni 6 Mn Bal Fe), nickel, and nickel-silver and manganese bronze (e.g., includes manganese, copper and nickel, such as 72 Mn 18 Cu 10 Ni). Further, one or more additional layers of the multi-layer biasing member can include low expansion metal materials having lower coefficients of thermal expansion relative to the other layer and can include metals or metal alloys such as nickel-iron alloys such as Invar or Permalloys (e.g., includes nickel and iron, such as 36 Ni Bal Fe, 39 Ni Bal Fe, 40 Ni Bal Fe, 42 Ni Bal Fe, 45 Ni Bal Fe, or 50 Ni Bal Fe), high performance alloys or super alloys such as for example Alloy 42, Haynes 188, and Inconel, (e.g., includes nickel, cobalt, molybdenum and iron, such as 32 Ni 15 Co 1 Mo Bal Fe or 32 Ni 1 Co 1 Mo Bal Fe), nickel-based alloys (e.g., includes nickel, chromium and iron, such as for example 38 Ni 7 Cr Bal Fe), and stainless steel (e.g., including chromium and iron, such as 17 Cr Bal Fe). The designation “Bal” indicates the remaining percentage of the material is made up of a balancing element, often a base metal, such as for example iron in the above examples. The layers can be secured or joined together using suitable techniques. If the layers are brazed together, than a suitable brazing material, such as copper, iron, or nickel, can be employed.

As used herein, the term “high coefficient of thermal expansion” refers to materials that expand or contract significantly when subjected to temperature changes (e.g., exposed to heating or cooling temperatures). The coefficient of thermal expansion can be measured in units of μm/m·° C. (micrometers per meter per degree Celsius). Materials with a high CTE experience more substantial dimensional changes for each degree of temperature increase or decrease compared to those with a low CTE. The high coefficient of thermal expansion can have measurements about 15 μm/m·° C. and higher. Common materials with a high CTE include aluminum (22-24 μm/m·° C.), brass (18-19 μm/m·° C.), plastics/polymers (50-150 μm/m·° C.—depending on type), and the like.

As used herein, the term “low coefficient of thermal expansion” refers to materials that exhibit minimal dimensional changes when subjected to temperature variations. The CTE is measured in μm/m.° C. (micrometers per meter per degree Celsius). Materials with a low CTE expand or contract only slightly with temperature changes, making them ideal for applications requiring dimensional stability under thermal stress. The low coefficient of thermal expansion can be less than or equal to about 10 μm/m·° C. Materials with low CTEs can include for example Invar (nickel-iron alloy—1-2 μm/m·° C.), silicon carbide (4-5 μm/m·° C.), quartz glass (0.5-1 μm/m·° C.), and the like.

The biasing member can employ first and second layers made of selected materials. When the material of one of the layers has a coefficient of thermal expansion between about 10-15 μm/m·° C., then the material can be deemed to have a low or high coefficient of thermal expansion depending upon the coefficient of thermal expansion of the material used in the adjacent layer. For example, if the material in the first layer has a coefficient of thermal expansion in this range (between about 10-15 μm/m·° C.), and the material used in the adjacent second layer has a coefficient of thermal expansion lower than this range, then the material in the first layer can be deemed to have a high coefficient of thermal expansion. Similarly, if the material in the adjacent second layer has a coefficient of thermal expansion higher than the material in the first layer (between about 10-15 μm/m·° C.), then the material in the first layer can be deemed to have a low coefficient of thermal expansion.

According to an alternate embodiment, the biasing member can be formed from multiple layers, where each layer is formed a material having a low coefficient of thermal expansion, and where the coefficients of thermal expansion are different from each other. Similarly, the biasing member can be formed from multiple layers, where each layer is formed a material having a high coefficient of thermal expansion, and where the coefficients of thermal expansion are different from each other.

FIG. 11 shows an example of a bimetallic biasing member 170 that can be subsequently shaped into any selected shape or configuration, such as the spiral shape, U-shaped configuration, wave shape, and the like, illustrated in the various embodiments. The illustrated biasing member 170 can include a first layer 172 formed of a first material and a second layer 174 formed of a second different material. According to one embodiment, the biasing member 170 the first layer 172 can be formed from a first type of metal material and the second layer 174 can be formed from a second, different type of metal material. For the sake of simplicity, the biasing member 170 is configured as an annulus. FIG. 12 illustrates another embodiment of the biasing member of the sealing member of the present invention. The illustrated biasing member is shown as a bimetallic biasing member 170 where the layers are reversed relative to the layers forming the biasing member 170 of FIG. 11. Specifically, the bimetallic biasing member has a first outer layer 182 formed of a first material and a second inner layer 184 formed of a second different material. Unlike homogeneous materials used in the construction of conventional biasing members and that are typically used in spring-energized seals, the bimetallic materials employed by the biasing member of the present invention provides the opportunity to automatically compensate for expansion and contraction which can be detrimental to effective sealing. The bimetallic construction of the biasing member of the present invention uses dissimilar metal materials that are bonded together. With each of the metals having different coefficients of thermal expansion, heating or cooling the material causes deformation of the material in a predicable manner. By constructing the biasing member from bimetallic material (e.g., layers of different types of metal materials), the sealing assembly of the present invention can be employed in environments that are exposed to extreme temperature conditions while maintaining a fluid seal.

The invention is described herein relative to illustrated embodiments. Those skilled in the art will appreciate that the present invention may be implemented in a number of different applications and embodiments and is not specifically limited in its application to the particular embodiment depicted herein.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

We claim:

1. A sealing assembly for use in a fluid regulating device for forming a seal with a movable shaft, comprising
a seal jacket having a main body having a channel formed therein, wherein the channel has opposed side wall portions, the seal jacket being sized and configured for seating in a channel formed in the fluid regulating device,
a biasing member sized and configured for seating in the channel and being formed from at least first and second layers, wherein the first layer is formed from a first metal material and the second layer is formed from a second metal material different than the first metal material,
wherein the biasing member places a force on the side wall portions of the channel when mounted therein.

2. The sealing assembly of claim 1, wherein the first and second layers of the biasing member are secured together to form a bimetallic biasing member.

3. The sealing assembly of claim 2, wherein the seal jacket has a base portion that is sized and dimensioned for seating within the channel of the fluid regulating device.

4. The sealing assembly of claim 1, wherein the first metal material has a first coefficient of thermal expansion and the second metal material has a second coefficient of thermal expansion, wherein the first coefficient of thermal expansion is different than the second coefficient of thermal expansion.

5. The sealing assembly of claim 1, wherein the first metal material has a high coefficient of thermal expansion and the second metal material has a low coefficient of thermal expansion.

6. The sealing assembly of claim 1, wherein the first metal material has a low coefficient of thermal expansion and the second metal material has a high coefficient of thermal expansion.

7. The sealing assembly of claim 4, wherein the first layer and the second layer are joined together.

8. The sealing assembly of claim 4, wherein the biasing member is configured as a spring element.

9. The sealing assembly of claim 8, wherein the spring element has a spiral shape or a U- shaped configuration.

10. The sealing assembly of claim 5, wherein the first layer is formed of brass and the second layer is formed of steel.

11. The sealing assembly of claim 4, wherein the first metal material of the first layer is formed from one of brass, stainless steel, nickel-based alloys low-alloy steel, bronze, nickel-manganese steel, nickel, and nickel-silver and manganese bronze, and the second metal material of the second layer is formed from one of nickel-iron alloys, alloy 42, Haynes 188, Inconel, nickel-based alloys, and steel.

12. The sealing assembly of claim 4, wherein the first metal material of the first layer is selected from the group consisting of brass, stainless steel, nickel-based alloys low-alloy steel, bronze, nickel-manganese steel, nickel, and nickel-silver and manganese bronze, and the second metal material of the second layer is selected from the group consisting of nickel-iron alloys, alloy 42, Haynes 188, Inconel, nickel-based alloys, and steel.

13. A method of forming a sealing assembly for use in a fluid regulating device for forming a seal with a movable shaft, comprising
providing a seal jacket having a main body having a channel formed therein, wherein the channel has opposed side wall portions, the seal jacket being sized and configured for seating in a channel formed in the fluid regulating device,
forming a biasing member sized and configured for seating in the channel and being formed from at least first and second layers, wherein the first layer is formed from a first metal material and the second layer is formed from a second metal material different than the first metal material,
wherein the biasing member places a force on the side wall portions of the channel when mounted therein.

14. The method of claim 13, wherein the first and second layers of the biasing member are secured together to form a bimetallic biasing member.

15. The method of claim 14, further comprising configuring the seal jacket to have a base portion that is sized and dimensioned for seating within the channel of the fluid regulating device.

16. The method of claim 13, wherein the first metal material has a first coefficient of thermal expansion and the second metal material has a second coefficient of thermal expansion, wherein the first coefficient of thermal expansion is different than the second coefficient of thermal expansion.

17. The method of claim 15, further comprising forming the biasing member to have a spiral shape or a U-shaped configuration.

18. The method of claim 16, further comprising forming the first layer of the biasing member of brass and forming the second layer of the biasing member of steel.

19. The method of claim 16, further comprising forming the first metal material of the first layer from one of brass, stainless steel, nickel-based alloys low-alloy steel, bronze, nickel-manganese steel, nickel, and nickel-silver and manganese bronze, and forming the second metal material of the second layer from one of nickel-iron alloys, alloy 42, Haynes 188, Inconel, nickel-based alloys, and steel.

20. The method of claim 16, further comprising forming the first metal material of the first layer from a material selected from the group consisting of brass, stainless steel, nickel-based alloys low-alloy steel, bronze, nickel-manganese steel, nickel, and nickel-silver and manganese bronze, and forming the second metal material of the second layer from a material selected from the group consisting of nickel-iron alloys, alloy 42, Haynes 188. Inconel, nickel-based alloys. and steel.
